(19) United States
(12) Patent Application Publication
(10) Pub. No.: US 2018/0145319 A1
(43) Pub. Date: May 24, 2018

(54) PRECURSOR OF CATHODE ACTIVE MATERIAL FOR LITHIUM SECONDARY BATTERIES, METHOD OF PREPARING SAME, CATHODE ACTIVE MATERIAL FOR LITHIUM SECONDARY BATTERIES, METHOD OF PREPARING SAME, AND LITHIUM SECONDARY BATTERY COMPRISING SAID CATHODE ACTIVE MATERIAL

(71) Applicant: Samsung SDI Co., Ltd., Yongin-si, Gyeonggi-do (KR)

(72) Inventors: Ki Tae KIM, Hwaseong-si (KR); Min Ah CHA, Suwon-si (KR); Jang Suk HYUN, Daejeon (KR)

(21) Appl. No.: 15/540,547

(22) PCT Filed: Aug. 21, 2015
(86) PCT No.: PCT/KR2015/008733

§ 371 Date: Jun. 28, 2017

(30) Foreign Application Priority Data
Dec. 31, 2014 (KR) 10-2014-0195935

(51) Int. Cl. H01M 4/525; H01M 4/505; H01M 4/1315; C01G 53/00; C01G 51/00; H01M 10/052

(52) U.S. Cl. CPC H01M 4/525; H01M 4/505; H01M 10/052; C01G 53/00; C01G 51/00; H01M 4/1315

(57) ABSTRACT

Provided are a precursor of cathode active material for lithium secondary batteries represented by the following formula, a method of preparing the same, a cathode active material for lithium secondary batteries, a method of preparing the same, and a lithium secondary battery comprising the cathode active material:

Ni_{y}M_{1-y-k}M′ₖ(OH)₂ Formula 1

wherein, M is at least one element selected from the group consisting of cobalt (Co) and manganese (Mn),

M′ is at least one element selected from the group consisting of magnesium (Mg), aluminum (Al), calcium (Ca), titanium (Ti), vanadium (V), chromium (Cr), iron (Fe), copper (Cu), zinc (Zn), gallium (Ga), strontium (Sr), yttrium (Y), zirconium (Zr), niobium (Nb), molybdenum (Mo), ruthenium (Ru), and fluorine (F),

0.8≤y<1, and 0.01<k<0.1.

### TECHNICAL FIELD

The present invention relates to a precursor of cathode active material for a lithium secondary battery, a method of preparing the same, a cathode active material for a lithium secondary battery, a method of preparing the same, and a lithium secondary battery including the cathode active material

### BACKGROUND ART

A nickel (Ni)-rich cathode active material among lithium metal oxides (LiMO₂) with a layered structure, in which Ni/M≥0.8, may implement a large capacity of about 200 milliampere-hours per gram (mAh/g) or greater, and thus is considered to be a suitable cathode material for next-generation electric vehicles and power storages. However, a Ni-rich lithium metal oxide may undergo a change in oxidation number of Ni, which may result in decreased crystallinity during calcination. Thus, a Ni-rich lithium metal oxide may have drawbacks such as a decrease in initial efficiency, deteriorated lifespan characteristics, an increase in lithium remaining on a surface, deteriorated thermal stability due to a side reaction with an electrolyte, and the generation of high-temperature gases.

In order to solve these drawbacks, a method of coating or doping the cathode active material itself is used, followed by secondary post-heat treatment. Also, in synthesizing a precursor, a metal precursor may be added together with a heterogenous element to be coated or doped. In this method, however, synthesis conditions for producing a hydroxide are changed, and thus, it is difficult to control the size, tap density, and shape of the basic precursor.

In the conventional art as described above, a heterogenous element is desired to be coated uniformly on a surface of the cathode active material or to be uniformly doped into a precursor. Among these methods, in particular, in the case of using a continuous type reactor, a problem, i.e., deterioration of the size uniformity due to overflow, may arise. In the case that a heterogenous element is coated on a cathode active material by a dry or wet method, the coating uniformity may be poor, and in particular, in the case of the dry method, a problem of loss of raw materials may occur. In addition, a problem of cost increase of the process due to the secondary heat treatment may occur. Furthermore, it is difficult to produce uniform products.

Accordingly, the present invention has been made as an endeavor to accomplish a new approach to incorporating a heterogenous element into the cathode active material in a relatively efficient manner and a method of manufacturing a cathode active material for improving characteristics of the battery.

### DETAILED DESCRIPTION OF THE INVENTION

### Technical Problem

The present invention provides a method of preparing a precursor, in which it is easy to control a size, tap density, and shape of the precursor, i.e., a basis of a cathode active material. In addition, the present invention provides a method of preparing a cathode active material improving characteristics of a lithium secondary battery and having an enhanced efficiency in processes. That is, in order to provide a battery that maintains a large capacity and has improved lifespan characteristics, the present invention provides a precursor for preparing a cathode active material and a method of preparing a cathode active material, which results in cost reduction due to simplified processes. In addition, the present invention provides a lithium secondary battery having improved lifespan characteristics by including a cathode active material prepared by using the method.

### Technical Solution

The present invention provides a precursor of a cathode active material for a lithium secondary battery represented by the following formula:

Ni_{y}M_{1-y-z}M′_{z}(OH)₂ Formula 1

wherein, M is at least one element selected from the group consisting of cobalt (Co) and manganese (Mn),

M′ is at least one element selected from the group consisting of magnesium (Mg), aluminum (Al), calcium (Ca), titanium (Ti), vanadium (V), chromium (Cr), iron (Fe), copper (Cu), zinc (Zn), gallium (Ga), strontium (Sr), yttrium (Y), zirconium (Zr), niobium (Nb), molybdenum (Mo), and ruthenium (Ru),

0.6≤y<1, and 0.01<z<0.1.

M′ is preferably a nanoparticle having a diameter in a range of 30 nanometers (nm) to 800 nm, and is present by being attached to a surface of a precursor.

The present invention provides a method of preparing a cathode active material precursor for a lithium secondary battery, the method including: preparing a metal precursor by adding a mixture solution including a nickel (Ni) compound and a compound including M, which is at least one element selected from the group consisting of Co and Mn, to a reactor containing a solvent including a hydroxyl group (—OH) to allow a reaction to occur; and preparing a precursor by adding a hydroxide of a doped material M′, which is at least one element selected from the group consisting of Mg, Al, Ca, Ti, V, Cr, Fe, Cu, Zn, Ga, Sr, Y, Zr, Nb, Mo, and Ru, to a solution including the metal precursor to co-deposit M′.

Preferably, the Ni compound is at least one selected from the group consisting of nickel sulfate, nickel nitrate, nickel chloride, and nickel fluoride, the Mn compound is at least one selected from the group consisting of manganese sulfate, manganese nitrate, manganese chloride, and manganese fluoride, and the Co compound is at least one selected from the group consisting of cobalt sulfate, cobalt nitrate, cobalt chloride, and cobalt fluoride.

Preferably, in the preparing of the metal precursor, a mixed solution is added to the reactor to allow a reaction to occur until obtaining a metal precursor having a particle size in a range of 3 micrometers (μm) to 15 μm and a tap density in a range of 1.8 grams per cubic centimeter (g/cc) to 2.0 g/cc.

Preferably, the metal precursor is a hydroxide of a metal.

Preferably, the reactor is a circulating batch reactor.

Preferably, the doped material M′ is added in a range of 0.01 equivalent to 0.1 equivalent with respect to a total amount of the metal precursor.

Preferably, before adding of the doped material M′, a pH of the solution including the metal precursor is adjusted to a range of 10 to 12, and after adding of doped material M′, the pH is gradually adjusted to a range of 9 to 10 during co-deposition.

The present invention provides a cathode active material represented by the following formula:

Li₁₊ₓNi_{y}M_{1-y-z}M′_{z}O₂ Formula 2

wherein, M is at least one element selected from the group consisting of cobalt (Co) and manganese (Mn),

M′ is at least one element selected from the group consisting of magnesium (Mg), aluminum (Al), calcium (Ca), titanium (Ti), vanadium (V), chromium (Cr), iron (Fe), copper (Cu), zinc (Zn), gallium (Ga), strontium (Sr), yttrium (Y), zirconium (Zr), niobium (Nb), molybdenum (Mo), and ruthenium (Ru),

0≤x≤0.2, 0.6≤y<1, and 0.01<z<0.1.

The present invention provides a method of preparing a cathode active material, the method including: mixing the precursor or a precursor prepared according to the foregoing method with at least one lithium salt compound selected from the group consisting of lithium hydroxide, lithium fluoride, lithium nitrate, lithium carbonate, and a combination thereof in a molar equivalent ratio of the precursor to lithium in a range of 1:1.01 to 1:1.20; and calcining at a temperature range of 700° C. to 850° C. for 10 hours to 20 hours.

The present invention provides a lithium secondary battery including the cathode active material and a cathode active material prepared according to the foregoing method.

### Advantageous Effects of the Invention

According to the present invention, a cathode active material for a Ni-rich lithium secondary battery having improved lifespan characteristics may be prepared. According to the present invention, in preparing a precursor of a cathode active material, a particle size, tap density, and a shape thereof may be uniformly controlled, and in doping a heterogenous element, problems such as non-uniformity of coating or loss of materials may not occur.

In addition, the simplified processes of the present invention may result in improved process efficiency and cost reduction.

### DESCRIPTION OF THE DRAWINGS

FIG. 1 illustrates an embodiment of a preparation process of a cathode active material according to the present invention;

FIG. 2 shows scanning electron microscope (SEM) images and focused ion beam (FIB) images of precursors and cathode active materials prepared in the Example and Comparative Examples 1 and 2;

FIG. 3 shows electron probe microanalysis (EPMA) images of the cathode active material prepared in the Example; and

FIG. 4 is a graph showing the change in capacity versus the number of charging and discharging cycles of a battery manufactured by using the cathode active materials prepared in the Example and Comparative Example 2.

### BEST MODE

The present invention relates to a precursor of a cathode active material for a lithium secondary battery, a method of preparing the precursor, a cathode active material prepared from the precursor, a method of preparing the cathode active material, and a lithium secondary battery including the cathode active material. In the present invention, in preparing the precursor, a doped material may be co-deposited on a surface of a metal precursor to prepare a precursor onto which the doped material is attached, and this precursor may be mixed with a lithium salt compound and undergo calcination, to thereby prepare a final cathode active material.

In detail, the precursor may be represented by the following formula:

Ni_{y}M_{1-y-z}M′_{z}(OH)₂ Formula 1

wherein, M may be at least one atom selected from the group consisting of cobalt (Co) and manganese (Mn),

M′ may be at least one element selected from the group consisting of magnesium (Mg), aluminum (Al), calcium (Ca), titanium (Ti), vanadium (V), chromium (Cr), iron (Fe), copper (Cu), zinc (Zn), gallium (Ga), strontium (Sr), yttrium (Y), zirconium (Zr), niobium (Nb), molybdenum (Mo), and ruthenium (Ru),

0.6≤y<1, and 0.01<z<0.1.

Here, M′ is a material doped on the final cathode active material, which is an element different from nickel (Ni), Co, and Mn included in a metal precursor in terms of its type. As described below, M′ may firstly be coated on a surface of a precursor, and then finally, be dispersed and doped in a cathode active material. Thus, in the present invention, M′ is referred as a heterogenous element, a doped material, or doped material M′.

M′ may be preferably a nanoparticle having a diameter in a range of 30 nanometers (nm) to 800 nm, and may be present by being attached to a surface of a precursor.

In order to prepare such a precursor, the present invention provides a method of preparing a precursor, the method including: preparing a metal precursor by adding a mixture solution including a Ni compound and a compound including M, which may be at least one element selected from the group consisting of Co and Mn, to a reactor containing a solvent including a hydroxyl group (—OH) to allow a reaction to occur; and finally preparing a precursor by adding a doped material M′, which may be at least one element selected from the group consisting of Mg, Al, Ca, Ti, V, Cr, Fe, Cu, Zn, Ga, Sr, Y, Zr, Nb, Mo, and Ru, to a solution including the metal precursor to co-deposit M′.

In the foregoing method, in order for a doped material of a nanoparticle to be included in a cathode active material, in preparing of a precursor, a metal precursor having a desired size and tap density and including M, which may be at least one element selected from the group consisting of Ni, Co, and Mn, may be firstly prepared. Then, the metal precursor may be co-deposited with a compound including a doped material in a specific pH range.

To this end, first, a metal precursor in the form of a hydroxide may be prepared from a Ni compound and a compound including M, which may be at least one selected from the group consisting of Co and Mn. Next, a compound including a doped material M′ may be promptly added to a solution including the metal precursor. Then, the pH of the solution including the metal precursor and the doped material may be adjusted for depositing the doped material M′ on a surface of the precursor, to thereby obtain a final precursor powder. A coating layer of the doped material M′ may be formed on a surface of the obtained precursor. However, since the coating layer is formed by the deposition of the doped material, the coating layer may not be uniform over the surface of the precursor; rather, the coating layer may be in a state in which the doped material is attached thereto non-uniformly. In the present invention, this state is also described as a shape in which the doped material M′ is ‘sitting’ on the surface of the precursor.

After the precursor is mixed with a lithium salt and undergoes calcination at a high temperature, the doped material, sitting on the surface of the precursor as such, may be uniformly dispersed inside a cathode active material. That is, the doped material may serve as filler which fills the inside of the cathode active material.

Accordingly, in the present invention, in order to dope a heterogenous element in a cathode active material, first, a metal precursor having a desired size and tap density may be prepared. Then, a doped material may be allowed to sit on a surface of the metal precursor to prepare a precursor, which may then be mixed with a lithium salt compound and undergo calcination, to thereby prepare a final cathode active material. The doped material is found to be uniformly dispersed inside the final cathode active material.

In the foregoing process, since a size and a tap density of the precursor is adjusted before adding of the doped material, a size and tap density of the final precursor may be adjusted to a desirable range, and since the doped material is allowed to sit non-uniformly on the surface of the precursor, it is not necessary to uniformly coat the doped material on the surface of the precursor as in the conventional art, or to uniformly dop thereinside. Nevertheless, the doped material is eventually dispersed inside the cathode active material according to the present invention, and thus, the battery may have improved lifespan characteristics.

In addition, as described above, in the process of preparing the cathode active material according to the present invention, heat-treatment may be performed only once, which may result in a shortened process and cost reduction.

The Ni compound may be at least one selected from nickel sulfate, nickel nitrate, nickel chloride, and nickel fluoride, the Mn compound may be at least one selected from manganese sulfate, manganese nitrate, manganese chloride, and manganese fluoride, and the Co compound may be at least one selected from cobalt sulfate, cobalt nitrate, cobalt chloride, and cobalt fluoride.

In addition, Examples of the compound including the doped material M′ include aluminum sulfate (aluminum sulfate hexadecahydrate) or aluminum nitrate (aluminum nitrate enneahydrate (nonahydrate)), which may be added to a reactor as an aqueous solution.

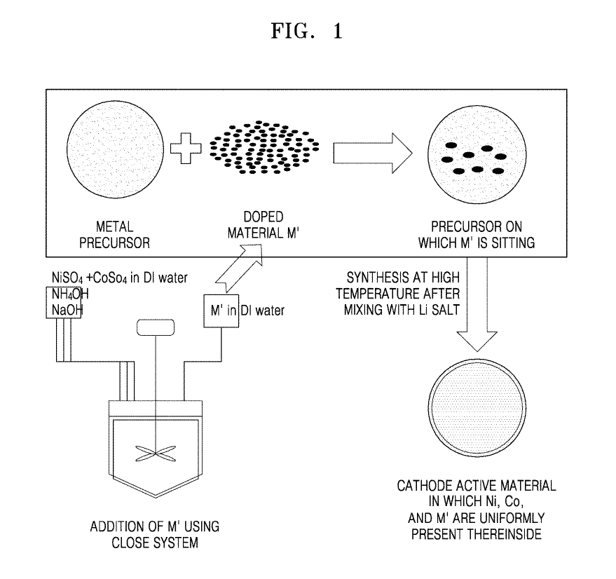

The mixture solution of the metal may be added into the circulating batch reactor as shown in FIG. 1 for the mixture solution to react with the solvent including a hydroxyl group (—OH), e.g., a basic solution such as NH₄OH or NaOH, thereby preparing a precursor as a hydroxide. The addition and reaction of the mixture solution may be performed until the obtained metal precursor has a tap density in a range of 1.8 g/cc to 2.0 g/cc and a size in a range of 3 μm to 15 μm. Then, the addition of the mixture solution may be stopped. In this case, the temperature of the reactor may be in a range of 30° C. to 60° C., and the stirring rate may be in a range of 500 rotations per minute (rpm) to 1,000 rpm.

Next, in allowing the doped material M′ to sit on a surface of the precursor, first, a pH of the solution containing the prepared precursor in the reactor may be adjusted to 11 to 12, the doped material M′ (at least one element selected from the group consisting of Mg, Al, Ca, Ti, V, Cr, Fe, Cu, Zn, Ga, Sr, Y, Zr, Nb, Mo, and Ru) may be added to the reactor such that the amount of M′ may be in a range of 0.01 equivalent to 0.1 equivalent with respect to the total amount of the metal precursor, followed by mixing, and the pH of the solution may be gradually lowered to a range of 9 to 10 during co-deposition.

Here, when the amount of the doped material is less than 0.01 equivalent with respect to the total amount of the metal precursor, the surface of the precursor particles may not be totally coated, which may result in poor electrochemical characteristics of the cathode active material. When the amount of the doped material is greater than 0.1 equivalent, the amount of the doped material may be excessive, which may result in a slow diffusion of lithium, and thus, the electrochemical characteristics of the cathode active material may become poor.

In order to adjust the pH, a pH adjusting agent selected from the group consisting of an ammonia aqueous solution, a carbonic acid gas, a compound including an —OH group, and a combination thereof may be used.

The reactor used in the preparing of the precursor may be preferably a circulating batch reactor as shown in FIG. 1. In such a reactor, a metal precursor may be first prepared in a closed system, and then the heterogenous element M′ may directly participate in the reaction. Accordingly, a desired size or a desired tap density may be controlled, and further, a problem of loss of raw materials may not occur.

One lithium salt compound selected from the group consisting of lithium hydroxide, lithium fluoride, lithium nitrate, lithium carbonate, and a combination thereof may be mixed with the prepared precursor, and then, the mixture may be calcined at a temperature range of 700° C. to 850° C. for 10 hours to 20 hours, thereby completing the preparation of a cathode active material. When the temperature is lower than 700° C., the prepared cathode active material may have an undesirable reduced capacity, and when the temperature is higher than 850° C., the prepared cathode active material may have an undesirable reduced capacity.

In the calcination process, the precursor and the lithium salt compound may be mixed in a molar ratio in a range of 1:1 to 1:1.20.

The cathode active material according to the present invention and prepared by the aforementioned method may be, for example, represented by the following formula:

Li₁₊ₓNi_{y}M_{1-y-z}M′_{z}O₂ Formula 2

wherein, M may be at least one element selected from the group consisting of cobalt (Co) and manganese (Mn),

M′ may be at least one element selected from the group consisting of magnesium (Mg), aluminum (Al), calcium (Ca), titanium (Ti), vanadium (V), chromium (Cr), iron (Fe), copper (Cu), zinc (Zn), gallium (Ga), strontium (Sr), yttrium (Y), zirconium (Zr), niobium (Nb), molybdenum (Mo), and ruthenium (Ru),

0≤x≤0.2, 0.6≤y<1, and 0.01<z<0.1.

According to the present invention, provided is a lithium secondary battery including the cathode active material. The lithium secondary battery may include a cathode including the cathode active material according to the present invention, an anode including an anode active material such as artificial graphite, natural graphite, a graphitized carbon fiber, or amorphous carbon, and a separator disposed therebetween. The lithium secondary battery may further include a cathode, an anode, and a liquid or polymer gel electrolyte including a lithium salt and a nonaqueous organic solvent impregnated in a separator.

Hereinafter, the present invention will be described in detail with reference to Examples of the present invention, but the present invention is not limited thereto.

### EXAMPLE

(1) Preparation of Precursor

4.8 L of deionized water, NaOH, and ammonia were added to a circulating batch reactor (as shown in FIG. 1, a 5 litres (L) reactor having a stirring power of 3.5 kilowatt-hours per cubic meter (kW/m³)) to obtain a 0.04 M of NaOH and 0.275 M of NH₄OH. Then, 2 M of a NiSO₄ and CoSO₄ aqueous solution, 4.34 M of a NaOH aqueous solution, and 5 M of an ammonia aqueous solution were each prepared, which were supplied to the reactor at a rate of 1 mol/hour, 2 mol/hour, and 0.3 mol/hour, respectively. The temperature of the reactor was 40° C., and the pH thereof was 11. Next, as a doped material, an Al aqueous solution (0.5 M of an aqueous solution of aluminum sulfate (aluminum sulfate hexadecahydrate (fluka 95%))) was prepared, which was then added to the reactor together with the NaOH aqueous solution and the NH₄OH aqueous solution. Thereafter, the pH of the solution in the reactor was gradually lowered to 9 while the reaction was ongoing. The added amounts of Ni, Co, and Al were adjusted such that the final precursor had a molar ratio of nickel to cobalt to aluminum of 0.8:0.15:0.05.

(2) Preparation of Cathode Active Material

30 grams (g) of the precursor Ni_{0.8} Co_{0.15}Al_{0.05}(OH)₂, obtained as described above, was mixed with 13.80 g of LiOH(H₂O). Then, calcination was performed thereon under an oxidation atmosphere at a temperature of 700° C. for 10 hours, thereby obtaining Li_{1.05}Ni_{0.8} Co_{0.15}Al_{0.05}O₂ cathode active material powder.

### Comparative Example 1

A precursor was prepared in the same manner as in the Example described above, except that the NiSO₄ aqueous solution and the doped material Al were together added to the reactor from the beginning of the preparation of the precursor. Then, a cathode active material was prepared in the same manner as in the Example described above.

### Comparative Example 2

A precursor was prepared in the same manner as in the Example described above, except that the doped material Al was not added during the preparation of the precursor. Then, a cathode active material was prepared in the same manner as in the Example described above.

(Measurement of Tap Density of Precursor)

The tap density of the precursors prepared in the Example and the Comparative Examples were measured. The tap density of the precursor was measured with 10 g of the precursor using GeoPyc 1360 available from Micromeritics, Co., Ltd. The results thereof are shown in Table 1.

(Observation on Precursor and Cathode Active Material Powder)

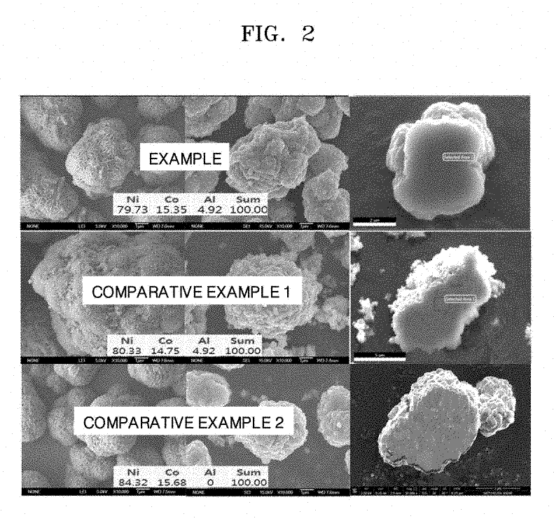

The precursors and the cathode active material powder prepared in the Example and the Comparative Examples were observed using a scanning electron microscope (SEM, JSM-7600F available from JEOL Co., Ltd.). A cross-section of the cathode active material was observed using a focused ion beam (FIB) apparatus (Helios 450 Hp, available from FEI). The composition of the cathode active material was analyzed using Electron Probe Micro-Analysis (EPMA, E-EPMA JXA-8530F available from JEOL Co., Ltd.). In FIG. 2, the left side images are SEM images of the precursor powder prepared in the Example and Comparative Examples 1 and 2, the central images are SEM images of the cathode active materials of the Example and Comparative Examples 1 and 2, and the right side images are FIB images of the cathode active materials of the Example and Comparative Examples 1 and 2. By comparing the Example with Comparative Example 2, it can be seen that Al is sitting on the surface of the precursor in the Example. Further, when Al is added from the beginning as in Comparative Example 1, Al is formed on the surface of the precursor; however, as described below, the lifespan characteristics of the battery may be poor.

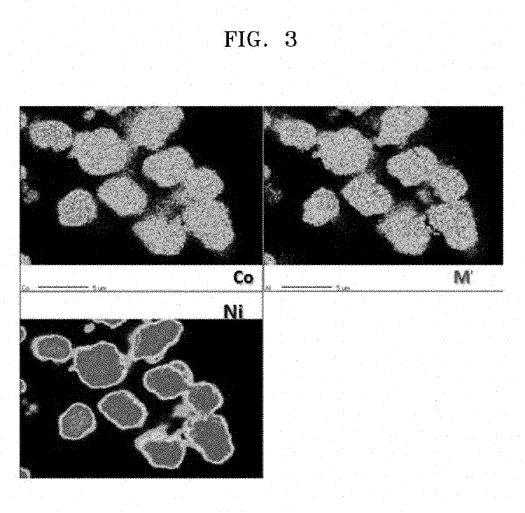

FIG. 3 is an EPMA image of the cathode active material prepared in the Example. As shown in FIG. 3, it can be seen that the doped material is uniformly dispersed inside the cathode active material.

(Measurement of Characteristics of Lithium Battery)

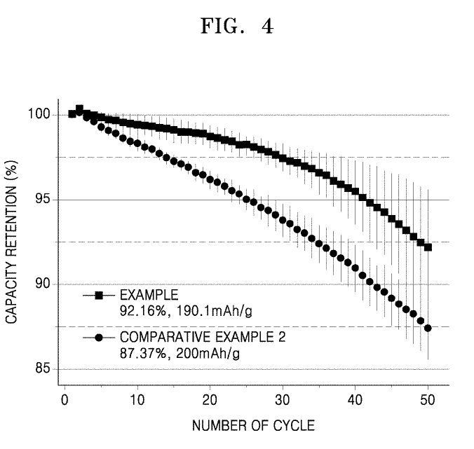

The cathode active material powder prepared in the Example and the Comparative Examples, acetylene black as a conductive agent, and polyvinylidene fluoride (PVdF) as a binder were mixed in a weight ratio of 85:7.5:7.5 to prepare a slurry. The slurry was coated uniformly on an aluminum foil to a thickness of 20 μm, and then dried under vacuum at a temperature of 120° C., thereby completing the manufacture of a cathode. A coin battery was manufactured using the manufactured cathode and a lithium foil as a counter electrode, a porous polyethylene film (Celgard 2300 manufactured by Celgard Llc, having a thickness of 25 μm) as a separator, and a liquid, in which LiPF₆ was dissolved at a concentration of 1 M in a mixed solvent of ethylene carbonate and diethyl carbonate in a volume ratio of 1:1, as an electrolytic solution. The manufactured coin batteries underwent a charging and discharging test using an electrochemical analyzer (Toscat 3100U available from Toyo System Co., Ltd.) at a temperature of 30° C., at a voltage in a range of 3.0 V to 4.3 V, at a cycle rate of 0.1 C, 0.2 C, 0.5 C, and 1 C. The measurement results of the capacity of the batteries and the capacity retention after performing 50 cycles at a rate of 1 C are shown in Table 1. The batteries manufactured using the active materials prepared in the Example and Comparative Example 2 underwent 50 cycles of charging and discharging at a rate of 1 C. The change in capacity is shown in FIG. 4.

TABLE 1

| | Tap density of | | | | | Lifespan |
|---|---|---|---|---|---|---|
| | precursor | 0.1 C C | 0.1 C D | 0.2 C D | 0.5 C D | (1 C, 50 cycles) |
| | g/cm³ | mAh/g | mAh/g | mAh/g | mAh/g | % |
| Example | 1.98 | 210.75 | 193.41 | 190.12 | 182.33 | 92.2 |
| Comparative | 1.37 | 213.60 | 194.70 | 190.80 | 183.30 | 90.8 |
| Example 1 | | | | | | |
| Comparative | 1.99 | 216.69 | 204.02 | 200.05 | 191.20 | 87.4 |
| Example 2 | | | | | | |

C: Capacity while charging,
D: Capacity while discharging

In Table 1, in the case of Comparative Example 1, in which the doped material was added from the beginning of the preparation of the precursor, the precursor powder had a lower tap density than the precursor powder in the Example. In other words, in the case that the doped material was added together from the beginning of the preparation of the precursor, the precursor was not prepared to have a desired level (1.8 g/cm³ to 2.0 g/cm³) of a tap density; however, in the case of the present invention, the tap density of the precursor was adjusted to be within the desired range.

In addition, upon viewing the SEM images of the precursors and cathode active material powder in FIG. 2, it can be seen that the shape of the precursor of Comparative Example 1 was not controlled, as compared with that of the Example. Thus, considering these results in conjunction with the results of the tap density shown in Table 1, it was easy to control the tap density and the shape of the precursor according to the present invention, as compared with that of the case in which the doped material was added from the beginning of the preparation of the precursor.

Regarding the capacity, even at the rate of 0.5 C, it can be seen that the cathode active material of the Example exhibited 180 mAh/g or greater capacity. Thus, it was found that large capacity characteristics were maintained.

In the cathode active material of the present invention, the lifespan characteristics of the battery improved. In order to verify that the lifespan characteristics improved, the capacity retention after 50 cycles of charging and discharging at 1 C were compared. As a result, it was found that the battery including the cathode active material of the present invention exhibited excellent lifespan characteristics, compared to those of Comparative Examples 1 and 2. In particular, in FIG. 4, considering changes in capacity upon performing charging and discharging cycles at a rate of 1 C with regard to the batteries of the Example and Comparative Example 2, in which the doped material was not added, the cathode active material according to the present invention was found to significantly have an excellent capacity retention.

1. A precursor of a cathode active material for a lithium secondary battery represented by the formula below:
Ni_{y}M_{1-y-z}M′_{z}(OH)₂ Formula 1
wherein, M is at least one element selected from the group consisting of cobalt (Co) and manganese (Mn),
M′ is at least one element selected from the group consisting of magnesium (Mg), aluminum (Al), calcium (Ca), titanium (Ti), vanadium (V), chromium (Cr), iron (Fe), copper (Cu), zinc (Zn), gallium (Ga), strontium (Sr), yttrium (Y), zirconium (Zr), niobium (Nb), molybdenum (Mo), and ruthenium (Ru),
0.6≤y≤1, and 0.01<z<0.1.

2. The precursor of claim 1, wherein M′ is a nanoparticle having a diameter in a range of 30 nanometers (nm) to 800 nm, and is present by being attached to a surface of the precursor.

3. A method of preparing a cathode active material precursor for a lithium secondary battery, the method comprising: preparing a metal precursor by adding a mixture solution comprising a nickel (Ni) compound and a compound comprising M, which is at least one element selected from the group consisting of Co and Mn, to a reactor comprising a solvent comprising a hydroxyl group (—OH) to allow a reaction to occur; and preparing a precursor by adding a hydroxide of a doped material M′, which is at least one element selected from the group consisting of Mg, Al, Ca, Ti, V, Cr, Fe, Cu, Zn, Ga, Sr, Y, Zr, Nb, Mo, and Ru, to a solution comprising the metal precursor to co-deposit M′.

4. The method of claim 3, wherein the Ni compound is at least one selected from nickel sulfate, nickel nitrate, nickel chloride, and nickel fluoride, the Mn compound is at least one selected from manganese sulfate, manganese nitrate, manganese chloride, and manganese fluoride, and the Co compound is at least one selected from cobalt sulfate, cobalt nitrate, cobalt chloride, and cobalt fluoride.

5. The method of claim 3, wherein, in preparing of the metal precursor, a metal salt solution is added to the reactor to allow a reaction to occur until a metal precursor having a particle size in a range of 3 micrometers (μm) to 15 μm and a tap density in a range of 1.8 grams per cubic centimeter (g/cc) to 2.0 g/cc is obtained.

6. The method of claim 3, wherein the hydroxide of the doped material M′ is added to the reactor such that an amount of M′ is in a range of 0.01 equivalent to 0.1 equivalent with respect to a total amount of the metal precursor.

7. The method of claim 3, wherein, before adding of the hydroxide of the doped material M′, a pH of the solution comprising the metal precursor is adjusted to a range of 10 to 12, and after adding of the hydroxide of the doped material M′, the pH is gradually adjusted to a range of 9 to 10 during co-deposition.

8. A cathode active material for a lithium secondary battery represented by the formula below:
Li₁₊ₓNi_{y}M_{1-y-z}M′_{z}O₂ Formula 2
wherein, M is at least one element selected from the group consisting of cobalt (Co) and manganese (Mn),
M′ is at least one element selected from the group consisting of magnesium (Mg), aluminum (Al), calcium (Ca), titanium (Ti), vanadium (V), chromium (Cr), iron (Fe), copper (Cu), zinc (Zn), gallium (Ga), strontium (Sr), yttrium (Y), zirconium (Zr), niobium (Nb), molybdenum (Mo), and ruthenium (Ru),
0.6≤y≤1, and 0.01<z<0.1.

9. A method of preparing a cathode active material, the method comprising: mixing the precursor of claim 1 with at least one lithium salt compound selected from the group consisting of lithium hydroxide, lithium fluoride, lithium nitrate, lithium carbonate, and a combination thereof in a molar equivalent ratio of the precursor to lithium in a range of 1:1 to 1:1.20; and calcining at a temperature range of 700° C. to 850° C. for 10 hours to 20 hours.

10. A lithium secondary battery comprising the cathode active material according to claim 8.
